(19) United States
(12) Patent Application Publication
(10) Pub. No.: US 2014/0057473 A1
(43) Pub. Date: Feb. 27, 2014

(54) CABLE CONNECTOR

(71) Applicant: Changzhou Ampherol Fuyang Communication Equip. Co. Ltd., (US)

(72) Inventors: Yiming XU, Changzhou (CN); Tingxing SHENG, Changzhou (CN)

(73) Assignee: Changzhou Amphenol Fuyang Communication Equipment Co., Ltd., Changzhou (CN)

(21) Appl. No.: 13/751,529

(22) Filed: Jan. 28, 2013

(30) Foreign Application Priority Data
Aug. 27, 2012 (CN) 201220426085.6

(51) Int. Cl. H01R 13/52

(52) U.S. Cl. CPC H01R 13/5202
USPC 439/275

(57) ABSTRACT

A cable connector that comprises a main housing that has first and second ends, a threaded sleeve coupled to the first end of the main housing and a protective housing the covers the main housing and is coupled to the second end of the main housing. The protective housing has an open end that covers the threaded sleeve. A sealing ring is disposed between the protective housing and the main housing at said second end of the main housing.

### RELATED APPLICATION

The present application claims priority under 35 U.S.C. §119 to Chinese Patent Application No. 201220426085.6; filed Aug. 27, 2012, the entire disclosure of which is incorporated by reference therein. The present application may be related to currently pending and commonly owned U.S. patent application Ser. No. ______, entitled Cable Connector and Connection System, concurrently filed herewith.

### FIELD OF THE INVENTION

The present invention relates to the technical field of cable connectors, and more particularly to a waterproof cable connector.

### BACKGROUND OF THE INVENTION

In mobile communication base stations or indoor coverage systems, connectors are indispensable for the transmission of high-frequency signal and power. Conventional cable connectors are mainly classified in two types: one that is equipped with annular corrugated cable; and two that is equipped with helically corrugated cable. In applications, such as outdoor antenna feed systems for mobile communication base stations, the primary method for protecting connectors from corrosion, such as from the aqueous solution of acidic and alkaline substances, is to use a daub adhesive tape to wrap the connectors. However, that method is ineffective in protecting connectors, thus leading to frequent water seepage in the connectors during use and thereby causing damage to associated equipment.

Therefore, there remains a need for a cable connector and connection system that protects against environmental damage, such as from water and corrosion.

### SUMMARY OF THE INVENTION

Accordingly, the present invention provides a cable connector that comprises a main housing that has first and second ends, a threaded sleeve coupled to the first end of the main housing and a protective housing the covers the main housing and is coupled to the second end of the main housing. The protective housing has an open end that covers the threaded sleeve. A sealing ring is disposed between the protective housing and the main housing at said second end of the main housing.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cross-sectional view of a cable connector according to an exemplary embodiment of the present invention; and

FIG. 2 is an elevational view of a protective housing of the cable connector illustrated in FIG. 1, showing the protective housing in partial cross-section.

### DETAILED DESCRIPTION OF THE EXEMPLARY EMBODIMENTS

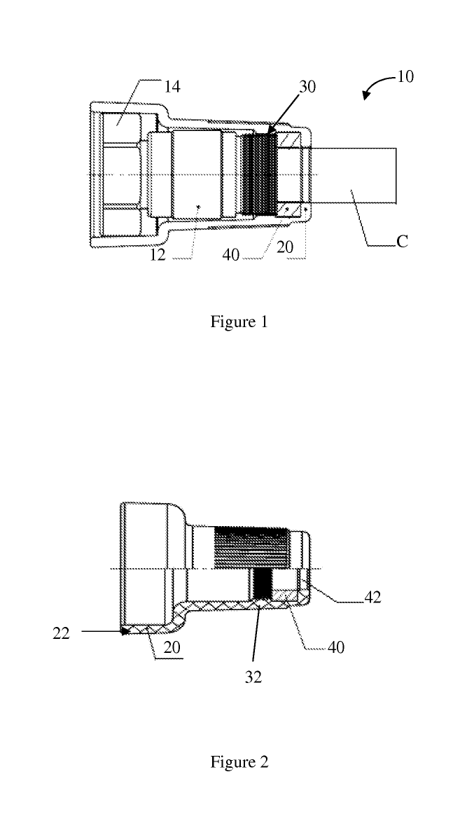

Referring to FIGS. 1 and 2, the present invention provides a cable connector design that is substantially water proof. The cable connector 10 according to the exemplary embodiments of the present invention solves the problem of protection against water, such as in outdoor antenna and feeder systems where protection from the corrosion and other environmental conditions is needed.

FIGS. 1 and 2 illustrate a cable connector 10 according to an exemplary embodiment of the present invention that generally comprises a main housing 12, a threaded sleeve 14 coupled to one end of the main housing 12, and a protective housing 20 coupled to the other end the main housing. The protective housing 20 covers the main housing 12 and is preferably structured in a shape of horn with an open end 22 facing towards the threaded sleeve 14. The protective housing 20 is preferably larger than the threaded sleeve 14. An outer thread 30 may be arranged on the tail part of the main housing 12 for engaging the protective housing 20. The protective housing 20 may be provided with an inner thread 32 that engages the outer thread 30 and may be arranged on the inner wall at the tail part of the protective housing 20. A rubber sealing ring 40 may be embedded in the end of the protective housing 20. The main housing 12 may be metal. The protective housing 20 may be plastic and may be formed by injection molding.

For assembly of the connector 10, one end of a cable C is extended through a connection opening 42 on the protective housing 20 to install the cable C in the connector 10. The protective housing 20 is then threaded onto the main housing 12, such that the sealing ring 40 is axially deformed to wrap around the cable C so that water is prevented from entering the tail part of the connector 10 along the cable C.

While particular embodiments have been chosen to illustrate the invention, it will be understood by those skilled in the art that various changes and modifications can be made therein without departing from the scope of the invention as defined in the appended claims.

What is claimed is:

1. A cable connector, comprising:
a main housing having first and second ends;
a threaded sleeve coupled to said first end of said main housing;
a protective housing covering said main housing and coupled to said second end of said main housing, and said protective housing having an open end covering said threaded sleeve; and
a sealing ring disposed between said protective housing and said main housing at said second end of said main housing.

2. A cable connector according to claim 1, wherein
said main housing is metal and said protective housing is plastic.

3. A cable connector according to claim 1, wherein
said protective housing is threadably coupled to said second end of said main housing.

4. A cable connector according to claim 1, wherein
said protection housing is structured in the shape of a horn.
